(19) United States
(12) Patent Application Publication
(10) Pub. No.: US 2024/0362150 A1
(43) Pub. Date: Oct. 31, 2024

(54) DEBUG CIRCUIT AND INFORMATION PROCESSING SYSTEM

(71) Applicant: LAPIS Technology Co., Ltd., Yokohama (JP)

(72) Inventor: Kenji NOZAKI, Yokohama (JP)

(73) Assignee: LAPIS Technology Co., Ltd., Yokohama (JP)

(21) Appl. No.: 18/642,829

(22) Filed: Apr. 23, 2024

(30) Foreign Application Priority Data
Apr. 25, 2023 (JP) 2023-071587

(51) Int. Cl. G06F 11/36

(52) U.S. Cl. CPC G06F 11/3648; G06F 11/3636

(57) ABSTRACT

A debug circuit is provided in an information processing device and performs debugging of a polling program that polls a flag of a control register used for control on a peripheral function of the information processing device. The debug circuit includes: an execution instruction detection circuit that detects an execution instruction of the peripheral function to generate a detection signal; an expected value comparison circuit that compares a flag value of a flag read from the control register against an expected value of the flag; and a polling time measurement circuit that measures a polling value related to polling of the flag of the control register based on the detection signal and a comparison result obtained by the expected value comparison circuit.

### CROSS-REFERENCE TO RELATED APPLICATION

This application claims the priority benefit of Japan application serial no. 2023-071587, filed on Apr. 25, 2023. The entirety of the above-mentioned patent application is hereby incorporated by reference herein and made a part of this specification.

### BACKGROUND

### Technical Field

The disclosure relates to a debug circuit and an information processing system that perform debugging of a program.

### Related Art

Debugging of programs is performed in computers such as a microcomputer. For example, in an information processing system that performs data transmission control between a host device and a workstation or the like by a polling processing, debugging of a program is performed using a debug device including a trace function part that traces the program being executed by the host device (e.g., Patent Document 1: Japanese Patent Application Laid-Open No. H5-233481).

Conventionally, debugging of a polling program of a control register for peripheral functions such as a special function register (SFR) built into a microcomputer is performed using a trace function or step execution function mounted on an in-circuit emulator (ICE) or on-chip debug emulator. For example, in the case of performing debugging of a program that polls a flag value of an SFR using the trace function, after dumping a trace content (e.g., a content of a program counter or an SFR) upon executing the program, the content from start of polling until the flag value of the SFR becomes an expected value is extracted, and debugging of a polling interval and a polling start timing is performed based on this content. Further, in the case of an ICE or the like without the trace function, debugging is performed while repeating step execution from start of polling until the flag value of the SFR matches the expected value.

However, in the case of performing debugging using the trace function, the content of the flag of the SFR is not reflected in the trace result until the content is read according to a read instruction (program), so the correct timing at which the flag changes cannot be learned.

Further, in the case of performing debugging using the step execution function, it takes time and effort because it is necessary to constantly confirm the content of the SFR while executing the program by one instruction at a time.

Further, in an application program that periodically performs polling of the flag value of an SFR in an interrupt processing routine occurring under specific conditions, in the case where it is desired to check for presence or absence of delay or omission in interrupt occurrence, efficient debugging cannot be performed with the trace function or step execution function alone.

### SUMMARY

A debug circuit according to an embodiment of the disclosure is a circuit provided in an information processing device and performing debugging of a polling program that polls a flag of a control register used for control on a peripheral function of the information processing device.

The debug circuit includes an execution instruction detection circuit, an expected value comparison circuit, and a polling time measurement circuit. The execution instruction detection circuit detects an execution instruction of the peripheral function to generate a detection signal. The expected value comparison circuit compares a flag value of a flag read from the control register against an expected value of the flag. The polling time measurement circuit measures a polling value related to polling of the flag of the control register based on the detection signal and a comparison result obtained by the expected value comparison circuit.

An information processing system according to an embodiment of the disclosure is composed of an information processing device and an external device connected to the information processing device via a bus line. The information processing device includes a debug circuit performing debugging of a polling program that polls a flag of a control register used for control on a peripheral function of the information processing device. The debug circuit includes an execution instruction detection circuit, an expected value comparison circuit, and a polling time measurement circuit. The execution instruction detection circuit detects an execution instruction of the peripheral function to generate a detection signal. The expected value comparison circuit compares a flag value of a flag read from the control register against an expected value of the flag. The polling time measurement circuit measures a polling value related to polling of the flag of the control register based on the detection signal and a comparison result obtained by the expected value comparison circuit. The external device acquires a measurement result of the polling time measurement circuit via the bus line and displays the measurement result in a visually confirmable manner.

### BRIEF DESCRIPTION OF DRAWINGS

FIG. 1 is a block diagram showing a configuration of an information processing system according to Embodiment 1 of the disclosure.

FIG. 2 is a flowchart showing a processing routine of a debug processing of Embodiment 1.

FIG. 3 is a flowchart showing a processing routine of the debug processing of Embodiment 1.

FIG. 4 is a block diagram showing a configuration of an information processing system according to Embodiment 2 of the disclosure.

FIG. 5 is a flowchart showing a processing routine of a debug processing of Embodiment 2.

FIG. 6 is a flowchart showing a processing routine of the debug processing of Embodiment 2.

FIG. 7 is a block diagram showing a configuration of an information processing system according to Embodiment 3 of the disclosure.

FIG. 8 is a flowchart showing a processing routine of a debug processing of Embodiment 3.

FIG. 9 is a flowchart showing a processing routine of the debug processing of Embodiment 3.

FIG. 10 is a flowchart showing a processing routine of the debug processing of Embodiment 3.

FIG. 11 is a block diagram showing a configuration of an information processing system according to Embodiment 4 of the disclosure.

FIG. 12 is a flowchart showing a processing routine of a debug processing of Embodiment 4.

FIG. 13 is a flowchart showing a processing routine of the debug processing of Embodiment 4.

### DESCRIPTION OF EMBODIMENTS

Embodiments of the disclosure provide a debug circuit capable of efficiently performing debugging of a polling program in a short time.

Hereinafter, embodiments of the disclosure will be described with reference to the drawings. In the following description and the accompanying drawings for each embodiment, substantially identical or equivalent parts will be labeled with the same reference signs.

### Embodiment 1

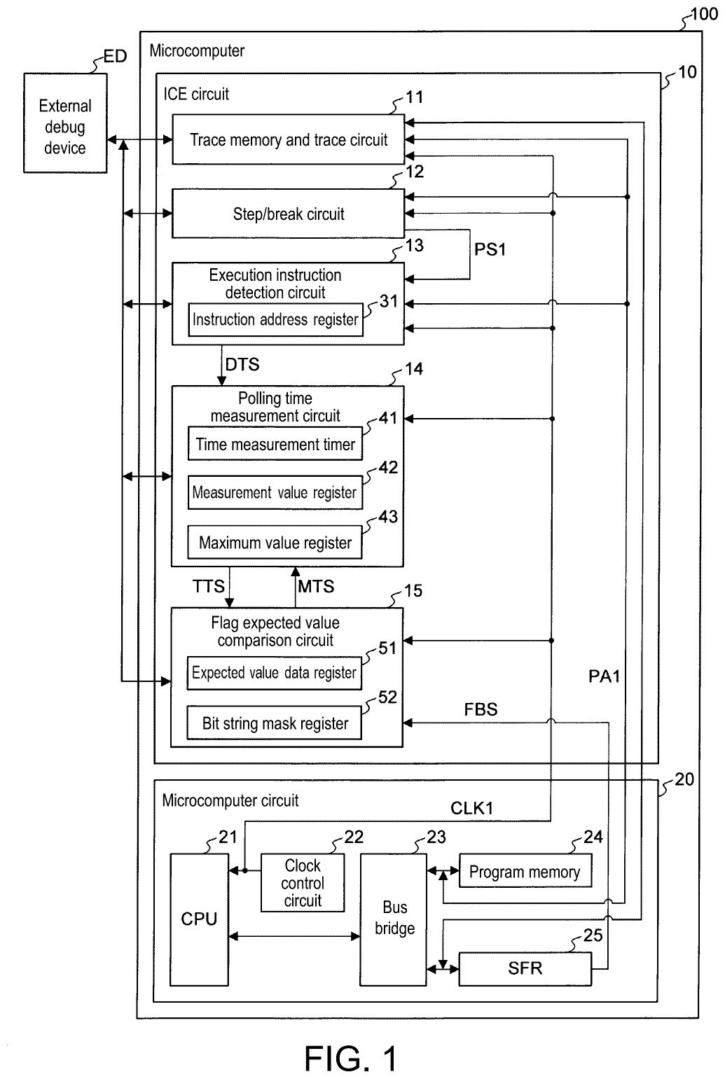

FIG. 1 is a block diagram showing a configuration of an information processing system according to Embodiment 1 of the disclosure. The information processing system of this embodiment is composed of an external debug device ED and a microcomputer 100. The microcomputer 100 is composed of an in-circuit emulator (ICE) circuit 10 and a microcomputer circuit 20.

The ICE circuit 10 includes a trace memory and trace circuit 11, a step/break circuit 12, an execution instruction detection circuit 13, a polling time measurement circuit 14, and a flag expected value comparison circuit 15. These circuits are connected to the external debug device ED via a communication bus BL.

The trace memory and trace circuit 11 is a circuit that fulfills a trace function of recording an execution history of a program executed by the microcomputer circuit 20. A CPU clock CLK1 and a program execution address PA1 are supplied to the trace memory and trace circuit 11 from the microcomputer circuit 20.

The step/break circuit 12 is a circuit that fulfills a step execution function of executing the program by one instruction at a time. The CPU clock CLK1 and the program execution address PA1 are supplied to the step/break circuit 12 from the microcomputer circuit 20.

The execution instruction detection circuit 13 is a circuit that detects an execution instruction of a control program for peripheral functions of the microcomputer circuit 20. Further, the execution instruction detection circuit 13 detects whether there is execution of a comparison instruction (hereinafter referred to as a polling instruction) for comparing a flag value (e.g., a flag indicating a communication end which changes from 0 to 1 at the communication end in a control program of UART communication) of an SFR 25 against an expected value. The CPU clock CLK1, the program execution address PA1, and a program start signal PS1 are supplied to the execution instruction detection circuit 13.

The execution instruction detection circuit 13 includes an instruction address register 31 that stores a physical address value on an application program. The execution instruction detection circuit 13 outputs a one-shot execution detection trigger pulse signal DTS in the case where the physical address value matches the value of the program execution address PA1.

The polling time measurement circuit 14 is a circuit that measures a polling value related to polling of the flag of the SFR 25. In this embodiment, the polling time measurement circuit 14 measures, as a polling value, a time from after detection of an execution instruction by the execution instruction detection circuit 13 until the flag value of the SFR 25 and its expected value change from a mismatch state to a match state.

The polling time measurement circuit 14 includes a time measurement timer 41, a measurement value register 42, and a maximum value register 43. The CPU clock CLK1 is supplied to the polling time measurement circuit 14. Further, an expected value match trigger pulse signal MTS is supplied to the polling time measurement circuit 14 from the flag expected value comparison circuit 15.

The time measurement timer 41 measures a polling time by performing counting based on the CPU clock CLK1. The measurement value register 42 stores a latest polling time measurement result obtained by the time measurement timer 41. The maximum value register 43 stores a maximum value (maximum value of the polling time) among measurement values indicating the polling time measurement results. The polling time measurement circuit 14 outputs a one-shot time measurement start trigger pulse signal TTS at the start of polling time measurement.

The flag expected value comparison circuit 15 includes an expected value data register 51 and a bit string mask register 52. A bit string FBS composed of the flag value of the SFR 25 is supplied to the flag expected value comparison circuit 15.

The expected value data register 51 stores an expected value data having a same bit width as the bit string FBS. The bit string mask register 52 stores a bit mask value for extracting a bit string with a same bit width as the bit string FBS. The flag expected value comparison circuit 15 compares a value of a logical product between the bit string FBS and the bit mask value read from the bit string mask register 52 against the expected value data read from the expected value data register 51. The flag expected value comparison circuit 15 outputs a one-shot expected value match trigger pulse signal MTS in the case where the value of the logical product and the expected value data change from a mismatch state to a match state.

The microcomputer circuit 20 includes a CPU 21, a clock control circuit 22, a bus bridge 23, a program memory 24, and an SFR 25.

The CPU (central processing unit) 21 is a processing control part that controls an overall action of the microcomputer circuit 20. In this embodiment, the CPU 21 is connected to the program memory 24 and the SFR 25 via the bus bridge 23.

The clock control circuit 22 outputs the CPU clock CLK1, which is an action clock of the CPU 21. The CPU clock CLK1 is supplied not only to the CPU 21, but also to the trace memory and trace circuit 11, the step/break circuit 12, the execution instruction detection circuit 13, the polling time measurement circuit 14, and the flag expected value comparison circuit 15 of the ICE circuit 10.

The program memory 24 is a storage device that stores various programs executed by the microcomputer circuit 20. For example, a polling program for polling the flag value of the SFR 25 is stored in the program memory 24.

The SFR 25 is a special function register that stores register values used for control on peripheral functions of the microcomputer circuit 20. For example, register values indicating communication control and status of a universal asynchronous receiver transmitter (UART) function (not shown) built into the microcomputer circuit 20 are stored in the SFR 25.

Next, a processing action of a debug processing executed by the ICE circuit 10 of this embodiment will be described.

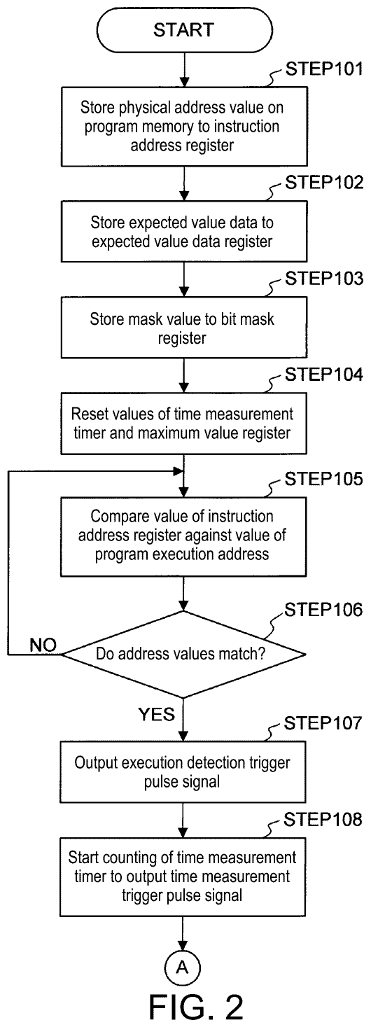

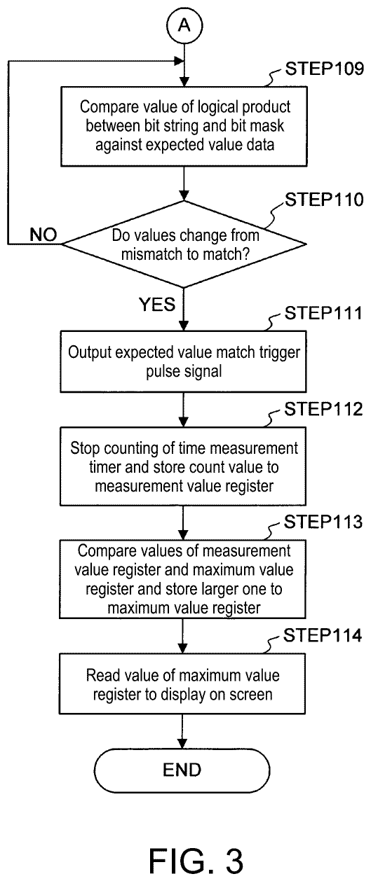

FIG. 2 and FIG. 3 are flowcharts showing a processing routine of the debug processing of Embodiment 1.

First, the ICE circuit 10 acquires a physical address value on the program memory 24, at which a polling instruction is stored, from the external debug device ED via the communication bus BL, and stores the physical address value to the instruction address register 31 of the execution instruction detection circuit 13 (STEP 101).

Further, the ICE circuit 10 acquires an expected value data of a flag of the SFR 25 from the external debug device ED via the communication bus BL, and stores the expected value data to the expected value data register 51 of the flag expected value comparison circuit 15 (STEP 102).

Further, the ICE circuit 10 acquires a bit mask value used for masking of the bit string FBS from the external debug device ED via the communication bus BL, and stores the bit mask value to the bit string mask register 52 of the flag expected value comparison circuit 15 (STEP 103).

The polling time measurement circuit 14 resets the values of the time measurement timer 41 and the maximum value register 43 to “0” (STEP 104).

When an application program starts, the execution instruction detection circuit 13 compares the physical address value stored in the instruction address register 31 against the value of a program execution address PA1 in synchronization with the CPU clock CLK1 (STEP 105).

As a result of the comparison, the execution instruction detection circuit 13 determines whether the two address values match (STEP 106).

If determining that the address values do not match (STEP 106: NO), returning to STEP 105, the execution instruction detection circuit 13 performs comparison of the address values again in synchronization with the CPU clock CLK1.

On the other hand, if determining that the address values match (STEP 106: YES), the execution instruction detection circuit 13 outputs an execution detection trigger pulse signal DTS indicating that an execution instruction has been detected (STEP 107).

The polling time measurement circuit 14 receives supply of the execution detection trigger pulse signal DTS and, in response thereto, starts counting of the time measurement timer 41. Further, the polling time measurement circuit 14 outputs a time measurement start trigger pulse signal TTS indicating that time measurement has started (STEP 108).

The flag expected value comparison circuit 15 compares a value of a logical product between the bit string FBS and the bit mask value read from the bit string mask register 52 against the expected value data read from the expected value data register 51, in synchronization with the CPU clock CLK1 (STEP 109).

As a result of the comparison, the flag expected value comparison circuit 15 determines whether the two values change from a mismatch state to a match state (STEP 110).

If determining that the values remain mismatched (STEP 110: NO), returning to STEP 109, the flag expected value comparison circuit 15 performs comparison of the value of the logical product against the expected value data again in synchronization with the CPU clock CLK1.

On the other hand, if determining that the values match (STEP 110: YES), the flag expected value comparison circuit 15 outputs an expected value match trigger pulse signal MTS indicating that the expected value matches (STEP 111).

The polling time measurement circuit 14 stops counting of the time measurement timer 41 upon receiving supply of the expected value match trigger pulse signal MTS, and stores the count value of the time measurement timer at that time as a measurement value to the measurement value register 42 (STEP 112).

The polling time measurement circuit 14 compares the measurement value stored in the measurement value register 42 against the maximum value read from the maximum value register 43, and stores the larger value as the maximum value (i.e., in the case where the measurement value is larger, it becomes a new maximum value) to the maximum value register 43 (STEP 113).

The external debug device ED periodically reads the maximum value stored in the maximum value register 43 of the polling time measurement circuit 14 via the communication bus BL, and displays the maximum value on a screen of a PC for monitoring (not shown in FIG. 1) connected to the external debug device ED (STEP 114).

As described above, in the information processing system of this embodiment, the execution instruction detection circuit 13, the polling time measurement circuit 14, and the flag expected value comparison circuit 15 are provided in the ICE circuit 10. According to this configuration, after starting polling of the flag value of the SFR 25, a time (maximum value) until the flag value and the expected value turn from a mismatch state into a match state can be measured and displayed on the monitor screen.

Accordingly, different from the case of performing debugging using a trace function in an ICE circuit without the circuits described above, herein, it is possible to learn about a correct timing at which the flag changes from a mismatch state to a match state. Further, different from the case of performing debugging by executing the program by one instruction at a time according to the step execution function, herein, debugging can be performed in a short time.

Thus, according to the ICE circuit 10 of this embodiment, debugging of the polling program can be efficiently performed in a short time.

### Embodiment 2

Next, Embodiment 2 of the disclosure will be described. The ICE circuit of this embodiment is different from the ICE circuit 10 of Embodiment 1 in that the ICE circuit of this embodiment has a configuration for measuring a time from after the flag value turns into a match state until polling starts.

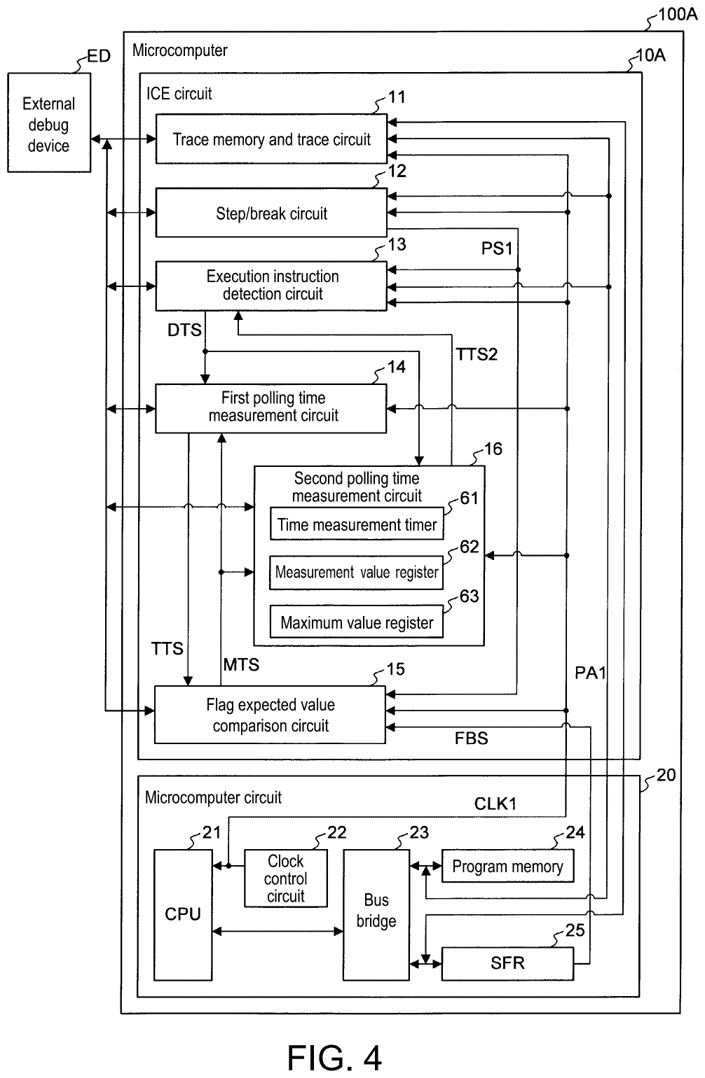

FIG. 4 is a block diagram showing a configuration of an information processing system according to Embodiment 2. The information processing system of this embodiment is composed of an external debug device ED and a microcomputer 100A. The microcomputer 100A is composed of an ICE circuit 10A and a microcomputer circuit 20. Herein, illustration of the internal configurations of the execution instruction detection circuit 13, a first polling time measurement circuit 14, and the flag expected value comparison circuit 15 is omitted.

The ICE circuit 10A includes a second polling time measurement circuit 16 in addition to the first polling time measurement circuit 14 having the same function as the polling time measurement circuit 14 of Embodiment 1.

The second polling time measurement circuit 16 is a circuit that measures, as a polling value, a time from a change of the flag value of the SFR 25 and its expected value from a mismatch state to a match state until polling of the SFR 25 starts.

The second polling time measurement circuit 16 includes a time measurement timer 61, a measurement value register 62, and a maximum value register 63. A CPU clock CLK1 is supplied to the second polling time measurement circuit 16. Further, an expected value match trigger pulse signal MTS is supplied to the second polling time measurement circuit 16 from the flag expected value comparison circuit 15.

The time measurement timer 61 measures a polling time by performing counting based on the CPU clock CLK1. The measurement value register 62 stores a latest polling time measurement result obtained by the time measurement timer 61. The maximum value register 63 stores a maximum value (maximum value of the polling time) among measurement values indicating the polling time measurement results.

The second polling time measurement circuit 16 outputs a one-shot time measurement start trigger pulse second signal TTS2 at the start of polling time measurement. The time measurement start trigger pulse second signal TTS2 is supplied to the execution instruction detection circuit 13.

Next, a processing action of a debug processing executed by the ICE circuit 10A of this embodiment will be described.

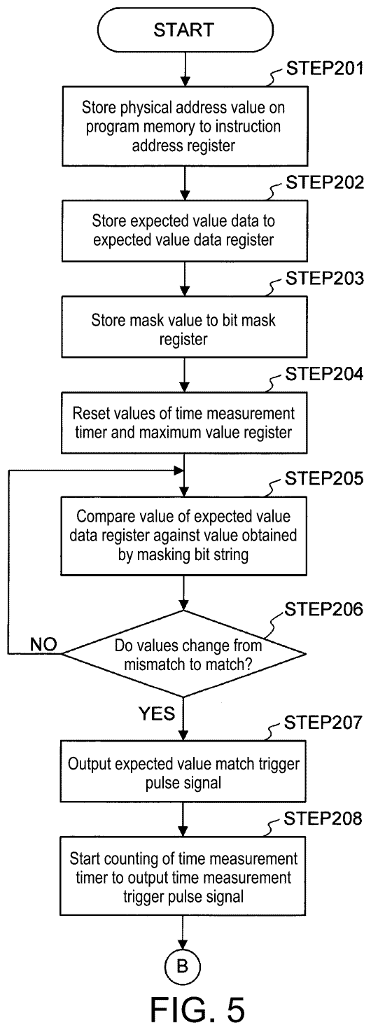

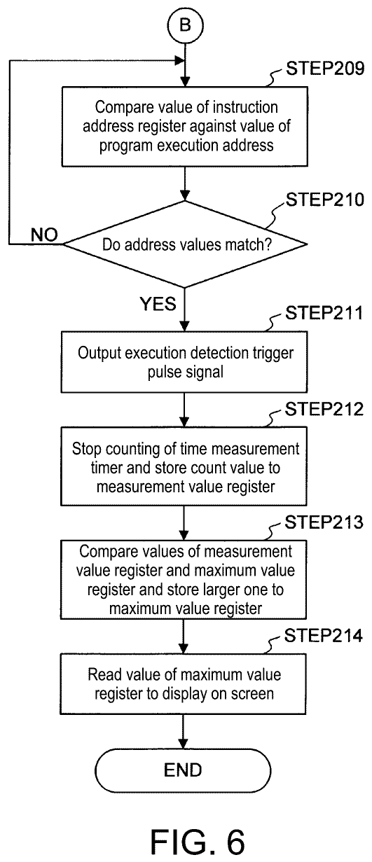

FIG. 5 and FIG. 6 are flowcharts showing a processing routine of the debug processing of Embodiment 2.

First, the ICE circuit 10A acquires a physical address value on the program memory 24, at which a polling instruction is stored, from the external debug device ED via the communication bus BL, and stores the physical address value to the instruction address register 31 of the execution instruction detection circuit 13 (STEP 201).

Further, the ICE circuit 10A acquires an expected value data of a flag of the SFR 25 from the external debug device ED via the communication bus BL, and stores the expected value data to the expected value data register 51 of the flag expected value comparison circuit 15 (STEP 202).

Further, the ICE circuit 10A acquires a bit mask value used for masking of the bit string FBS from the external debug device ED via the communication bus BL, and stores the bit mask value to the bit string mask register 52 of the flag expected value comparison circuit 15 (STEP 203).

The polling time measurement circuit 14 resets the values of the time measurement timer 41 and the maximum value register 43 to “0” (STEP 204).

When an application program starts, the flag expected value comparison circuit 15 compares a value obtained by masking the bit string FBS by the bit mask value read from the bit string mask register 52 against the expected value data read from the expected value data register 51, in synchronization with the CPU clock CLK1 (STEP 205).

As a result of the comparison, the flag expected value comparison circuit 15 determines whether the two values change from a mismatch state to a match state (STEP 206).

If determining that the values remain mismatched (STEP 206: NO), returning to STEP 205, the flag expected value comparison circuit 15 performs comparison of the value obtained by masking the bit string FBS against the expected value data again in synchronization with the CPU clock CLK1.

On the other hand, if determining that the values match (STEP 206: YES), the flag expected value comparison circuit 15 outputs an expected value match trigger pulse signal MTS indicating that the expected value matches (STEP 207).

The second polling time measurement circuit 16 receives supply of the expected value match trigger pulse signal MTS and, in response thereto, starts counting of the time measurement timer 61. Further, the second polling time measurement circuit 16 outputs a time measurement start trigger pulse second signal TTS2 indicating that time measurement has started (STEP 208).

The execution instruction detection circuit 13 receives supply of the time measurement start trigger pulse second signal TTS2 and, in response thereto, compares the physical address value stored in the instruction address register 31 against the value of a program execution address PA1 in synchronization with the CPU clock CLK1 (STEP 209).

As a result of the comparison, the execution instruction detection circuit 13 determines whether the two address values match (STEP 210).

If determining that the address values do not match (STEP 210: NO), returning to STEP 209, the execution instruction detection circuit 13 performs comparison of the address values again in synchronization with the CPU clock CLK1.

On the other hand, if determining that the address values match (STEP 210: YES), the execution instruction detection circuit 13 outputs an execution detection trigger pulse signal DTS indicating that an execution instruction has been detected (STEP 211).

The second polling time measurement circuit 16 stops counting of the time measurement timer 61 upon receiving supply of the execution detection trigger pulse signal DTS, and stores the count value of the time measurement timer at that time as a measurement value to the measurement value register 62 (STEP 212).

The second polling time measurement circuit 16 compares the measurement value stored in the measurement value register 62 against the maximum value read from the maximum value register 63, and stores the larger value as the maximum value (i.e., in the case where the measurement value is larger, it becomes a new maximum value) to the maximum value register 63 (STEP 213).

The external debug device ED periodically reads the maximum value stored in the maximum value register 63 of the second polling time measurement circuit 16 via the communication bus BL, and displays the maximum value on a screen of a PC for monitoring (not shown in FIG. 4) connected to the external debug device ED (STEP 214).

As described above, in the information processing system of this embodiment, the execution instruction detection circuit 13, the first polling time measurement circuit 14, the flag expected value comparison circuit 15, and the second polling time measurement circuit 16 are provided in the ICE circuit 10A. According to such a configuration, it is possible to measure a time (maximum value) from a change of the flag value and the expected value of the SFR 25 from a mismatch state to a match state until polling is started, and display the time on the monitor screen.

Thus, different from the case where debugging is performed using the trace function or step function in an ICE circuit without the circuits described above, herein, it is possible to efficiently perform debugging of delays in polling intervals and polling processing as well as processing omissions in a short time.

Thus, according to the ICE circuit 10A of this embodiment, debugging of the polling program can be efficiently performed in a short time.

### Embodiment 3

Next, Embodiment 3 of the disclosure will be described. The ICE circuit of this embodiment differs from the ICE circuit 10 of Embodiment 1 in that the ICE circuit of this embodiment has a configuration for measuring a polling count from start of polling until the flag value and the expected value change from a mismatch state to a match state.

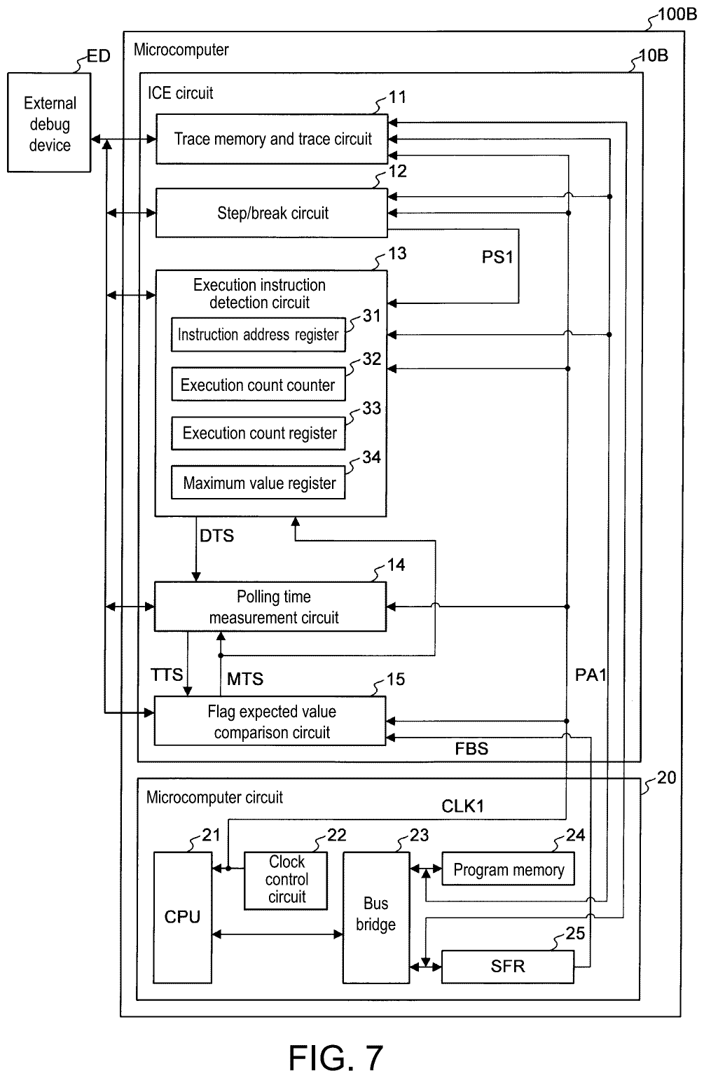

FIG. 7 is a block diagram showing a configuration of an information processing system according to Embodiment 3. The information processing system of this embodiment is composed of an external debug device ED and a microcomputer 100B. The microcomputer 100B is composed of an ICE circuit 10B and a microcomputer circuit 20. Herein, illustration of the internal configurations of the polling time measurement circuit 14 and the flag expected value comparison circuit 15 is omitted.

In addition to the instruction address register 31, the execution instruction detection circuit 13 of this embodiment further includes an execution count counter 32, an execution count register 33, and a maximum value register 34.

The execution count counter 32 is a counter for counting an execution count of the polling instruction. Specifically, the execution instruction detection circuit 13 performs comparison of a physical address value stored in the instruction address register 31 against a program execution address PA1 in synchronization with the CPU clock CLK1, and a count value of the execution count counter 32 is incremented each time the two values match.

The execution count register 33 is a register that stores the count value of the execution count counter 32. Specifically, a count value of the execution count counter 32 at a time point, at which the execution instruction detection circuit 13 stops incrementation of the execution count counter 32 upon receiving supply of an expected value match trigger pulse signal MTS, is stored to the execution count register 33.

The maximum value register 34 is a register that stores a maximum value (maximum value of an instruction execution count) of the count value of the execution count counter 32. The execution instruction detection circuit 13 compares the count value stored in the execution count register 33 against the count value stored in the maximum value register 34, and stores the larger count value as the maximum value to the maximum value register 34.

With the above configuration, the execution instruction detection circuit 13 of this embodiment has a function of measuring (counting) a count of pollings executed from start of polling of the SFR 25 until the flag value of the SFR 25 and its expected value change from a mismatch state to a match state.

Next, a processing action of a debug processing executed by the ICE circuit 10B of this embodiment will be described.

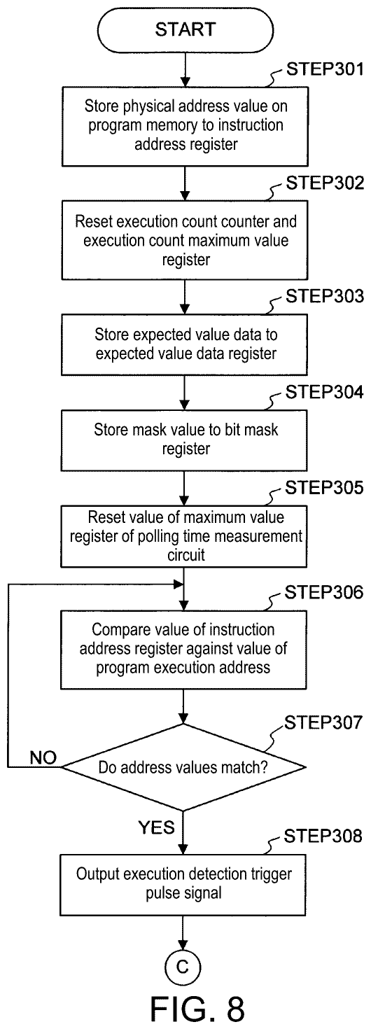

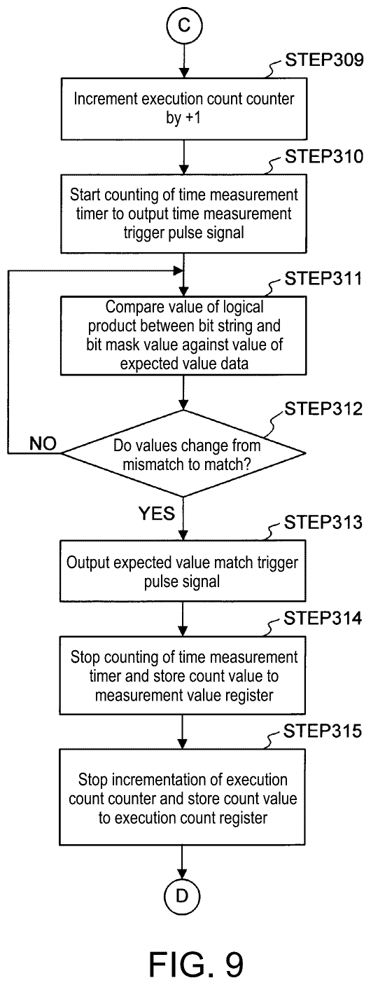

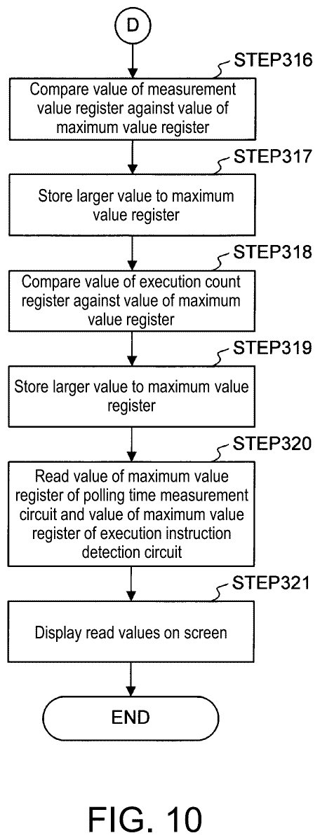

FIG. 8, FIG. 9, and FIG. 10 are flowcharts showing a processing routine of the debug processing of Embodiment 3.

First, the ICE circuit 10B acquires a physical address value on the program memory 24, at which a polling instruction is stored, from the external debug device ED via the communication bus BL, and stores the physical address value to the instruction address register 31 of the execution instruction detection circuit 13 (STEP 301).

The execution instruction detection circuit 13 resets the values of the execution count counter 32 and the maximum value register 34 to “0” (STEP 302).

Further, the ICE circuit 10B acquires an expected value data of the flag of the SFR 25 from the external debug device ED via the communication bus BL, and stores the expected value data to the expected value data register 51 of the flag expected value comparison circuit 15 (STEP 303).

Further, the ICE circuit 10B acquires a bit mask value used for masking of the bit string FBS from the external debug device ED via the communication bus BL, and stores the bit mask value to the bit string mask register 52 of the flag expected value comparison circuit 15 (STEP 304).

The polling time measurement circuit 14 resets the value of the maximum value register 43 to “0” (STEP 305).

When an application program starts, the execution instruction detection circuit 13 compares the physical address value stored in the instruction address register 31 against the address value of the program execution address PA1 in synchronization with the CPU clock CLK1 (STEP 306).

As a result of the comparison, the execution instruction detection circuit 13 determines whether the two address values match (STEP 307).

If determining that the values do not match (STEP 307: NO), returning to STEP 306, the execution instruction detection circuit 13 performs comparison of the physical address value stored in the instruction address register 31 against the address value of the program execution address PA1 again in synchronization with the CPU clock CLK1.

On the other hand, if determining that the values match (STEP 307: YES), the execution instruction detection circuit 13 outputs an execution detection trigger pulse signal DTS (STEP 308).

The execution instruction detection circuit 13 increments the count value of the execution count counter 32 by “+1” (STEP 309).

Thereafter, the execution instruction detection circuit 13 continues to perform comparison of the physical address value stored in the instruction address register 31 against the address value of the program execution address PA1, and increments the count value of the execution count counter 32 by “+1” each time the values match.

The polling time measurement circuit 14 receives supply of the execution detection trigger pulse signal DTS and, in response thereto, starts counting of the time measurement timer 41. Further, the polling time measurement circuit 14 outputs a time measurement start trigger pulse signal TTS indicating that time measurement has started (STEP 310).

The flag expected value comparison circuit 15 compares a value obtained by masking the bit string FBS by the bit mask value read from the bit string mask register 52 against the expected value data read from the expected value data register 51, in synchronization with the CPU clock CLK1 (STEP 311).

As a result of the comparison, the flag expected value comparison circuit 15 determines whether the two values have changed from a mismatch state to a match state (STEP 312).

If determining that the values remain mismatched (STEP 312: NO), returning to STEP 311, the flag expected value comparison circuit 15 performs comparison of the value obtained by masking the bit string FBS against the expected value data again in synchronization with the CPU clock CLK1.

On the other hand, if determining that the values match (STEP 312: YES), the flag expected value comparison circuit 15 outputs an expected value match trigger pulse signal MTS indicating that the expected value matches (STEP 313).

The polling time measurement circuit 14 stops counting of the time measurement timer 41 upon receiving supply of the expected value match trigger pulse signal MTS, and stores the count value of the time measurement timer at that time as a measurement value to the measurement value register 42 (STEP 314).

The execution instruction detection circuit 13 stops incrementation of the count value of the execution count counter 32 and stores the count value of the execution count counter 32 to the execution count register 33 (STEP 315).

The polling time measurement circuit 14 compares the measurement value stored in the measurement value register 42 against the maximum value read from the maximum value register 43 (STEP 316).

As a result of the comparison, the polling time measurement circuit 14 stores the larger value to the maximum value register 43 (STEP 317).

The execution instruction detection circuit 13 compares the count value stored in the execution count register 33 against the maximum value read from the maximum value register 34 (STEP 318).

As a result of the comparison, the execution instruction detection circuit 13 stores the larger count value to the maximum value register 34 (STEP 319).

The external debug device ED periodically reads the maximum value stored in the maximum value register 43 of the polling time measurement circuit 14 and the maximum value stored in the maximum value register 34 of the execution instruction detection circuit 13, respectively, via the communication bus BL (STEP 320).

The external debug device ED displays the maximum values on a screen of a PC for monitoring (not shown in FIG. 7) connected thereto (STEP 321).

As described above, in the information processing system of this embodiment, the execution instruction detection circuit 13, the polling time measurement circuit 14, and the flag expected value comparison circuit 15 are provided in the ICE circuit 10B. The execution instruction detection circuit 13 includes the instruction address register 31, the execution count counter 32, the execution count register 33, and the maximum value register 34. According to such a configuration, it is possible to count a count (maximum value) of pollings executed from start of polling until the flag value and the expected value change from a mismatch state to a match state, and display the count on a monitor screen.

Further, by the same action as the information processing system of Embodiment 1, it is possible to measure a time (maximum value) from start of polling of the flag value of the SFR 25 until the flag value and the expected value turn from a mismatch state to a match state, and display the time on a screen for monitoring (e.g., a screen of a PC).

Thus, according to the ICE circuit 10B of this embodiment, it is possible to visually confirm whether the polling program is acting according to the specification.

### Embodiment 4

Next, Embodiment 4 of the disclosure will be described. The ICE circuit of this embodiment is different from the ICE circuit 10 of Embodiment 1 in that the ICE circuit of this embodiment has a configuration for measuring a polling count until the flag value and the expected value change from a match state to a mismatch state.

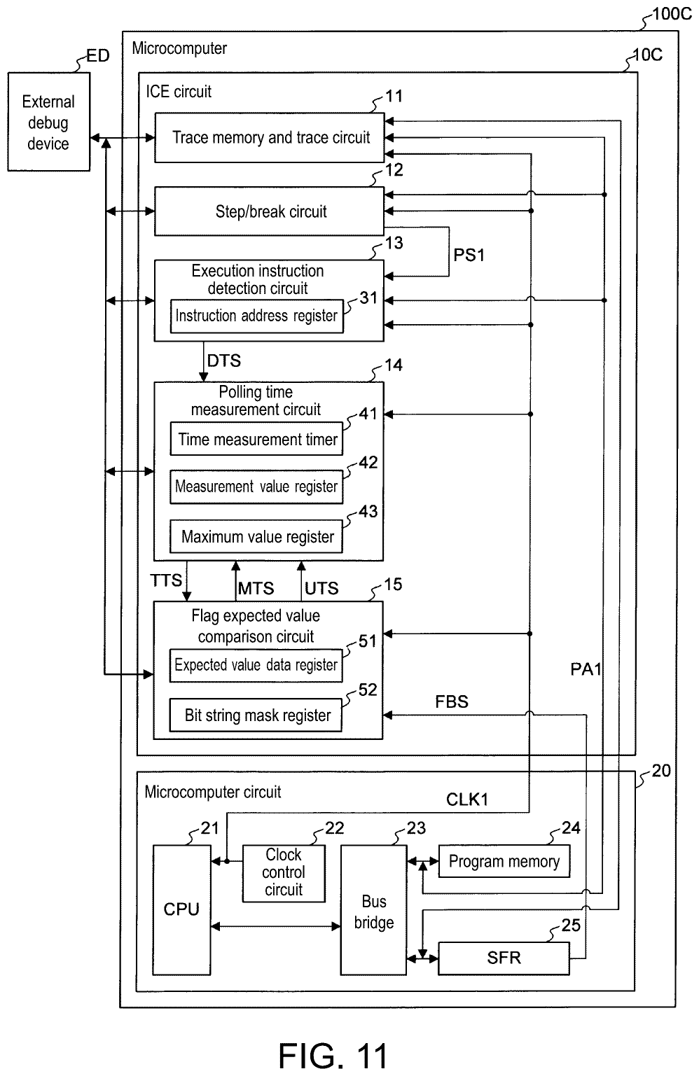

FIG. 11 is a block diagram showing a configuration of an information processing system according to Embodiment 4. The information processing system of this embodiment is composed of an external debug device ED and a microcomputer 100C. The microcomputer 100C is composed of an ICE circuit 10C and a microcomputer circuit 20.

The flag expected value comparison circuit 15 of this embodiment outputs a one-shot expected value mismatch trigger pulse signal UTS in the case where a value of a logical product between the bit string FBS and the bit mask value and the expected value data change from a match state to a mismatch state.

Next, a processing action of a debug processing executed by the ICE circuit 10C of this embodiment will be described.

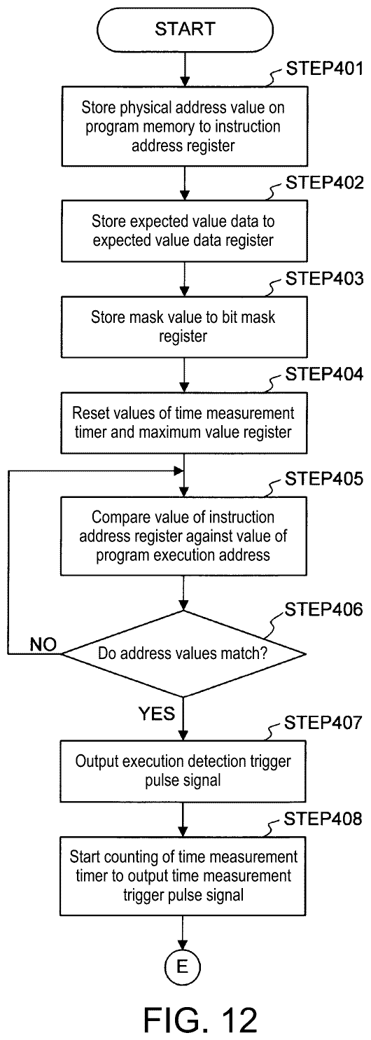

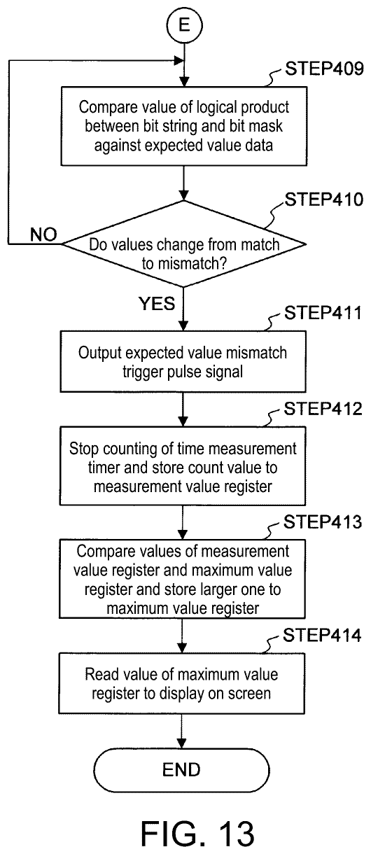

FIG. 12 and FIG. 13 are flowcharts showing a processing routine of the debug processing of Embodiment 4.

First, the ICE circuit 10C acquires a physical address value on the program memory 24, at which a polling instruction is stored, from the external debug device ED via the communication bus BL, and stores the physical address value to the instruction address register 31 of the execution instruction detection circuit 13 (STEP 401).

Further, the ICE circuit 10C acquires an expected value data of the flag of the SFR 25 from the external debug device ED via the communication bus BL, and stores the expected value data to the expected value data register 51 of the flag expected value comparison circuit 15 (STEP 402).

Further, the ICE circuit 10C acquires a bit mask value used for masking of the bit string FBS from the external debug device ED via the communication bus BL, and stores the bit mask value to the bit string mask register 52 of the flag expected value comparison circuit 15 (STEP 403).

The polling time measurement circuit 14 resets the values of the time measurement timer 41 and the maximum value register 43 to “0” (STEP 404).

When an application program starts, the execution instruction detection circuit 13 compares the physical address value stored in the instruction address register 31 against the value of a program execution address PA1 in synchronization with the CPU clock CLK1 (STEP 405).

As a result of the comparison, the execution instruction detection circuit 13 determines whether the two address values match (STEP 406).

If determining that the address values do not match (STEP 406: NO), returning to STEP 405, the execution instruction detection circuit 13 performs comparison of the address values again in synchronization with the CPU clock CLK1.

On the other hand, if determining that the address values match (STEP 406: YES), the execution instruction detection circuit 13 outputs an execution detection trigger pulse signal DTS indicating that an execution instruction has been detected (STEP 407).

The polling time measurement circuit 14 receives supply of the execution detection trigger pulse signal DTS and, in response thereto, starts counting of the time measurement timer 41. Further, the polling time measurement circuit 14 outputs a time measurement start trigger pulse signal TTS indicating that time measurement has started (STEP 408).

The flag expected value comparison circuit 15 compares a value of a logical product between the bit string FBS and the bit mask value read from the bit string mask register 52 against the expected value data read from the expected value data register 51, in synchronization with the CPU clock CLK1 (STEP 409).

As a result of the comparison, the flag expected value comparison circuit 15 determines whether the two values have changed from a match state to a mismatch state (STEP 410).

If determining that the values do not mismatch, that is, the values remain matched (STEP 410: NO), returning to STEP 409, the flag expected value comparison circuit 15 performs comparison of the value of the logical product against the expected value data again in synchronization with the CPU clock CLK1.

On the other hand, if determining that the values turn into a mismatch state (STEP 410: YES), the flag expected value comparison circuit 15 outputs an expected value mismatch trigger pulse signal UTS indicating that the expected value mismatches (STEP 411).

The polling time measurement circuit 14 stops counting of the time measurement timer 41 upon receiving supply of the expected value mismatch trigger pulse signal UTS, and stores the count value of the time measurement timer at that time as a measurement value to the measurement value register 42 (STEP 412).

The polling time measurement circuit 14 compares the measurement value stored in the measurement value register 42 against the maximum value read from the maximum value register 43, and stores the larger value as the maximum value (i.e., in the case where the measurement value is larger, it becomes a new maximum value) to the maximum value register 43 (STEP 413).

The external debug device ED periodically reads the maximum value stored in the maximum value register 43 of the polling time measurement circuit 14 via the communication bus BL, and displays the maximum value on a screen of a PC (not shown in FIG. 1) connected to the external debug device ED (STEP 414).

As described above, in the information processing system of this embodiment, when the flag value and the expected value change from a match state to a mismatch state, the flag expected value comparison circuit 15 of the ICE circuit 10C outputs an expected value mismatch trigger pulse signal UTS. According to such a configuration, it is possible to measure a time (maximum value) until the flag value and the expected value of the SFR 25 turn from a match state to a mismatch state, and display the time on a monitor screen.

The disclosure is not limited to the above embodiments. For example, with the configuration of Embodiment 1 taken as a basic configuration, Embodiment 4 has been described as an example in which the flag expected value comparison circuit 15 outputs an expected value mismatch trigger pulse signal UTS. However, the application target is not limited to Embodiment 1, and the flag expected value comparison circuit 15 of Embodiment 4 may also be combined with the configuration of Embodiment 2 and/or the configuration of Embodiment 3.

For example, in Embodiment 2, by configuring the flag expected value comparison circuit 15 to output an expected value mismatch trigger pulse signal UTS, it becomes possible to measure a time from a change of the flag value and the expected value of the SFR 25 from a match state to a mismatch state until polling starts.

Further, in Embodiment 3, by configuring the flag expected value comparison circuit 15 to output an expected value mismatch trigger pulse signal UTS, it becomes possible to count a count of pollings executed from start of polling until the flag value and the expected value change from a match state to a mismatch state.

What is claimed is:

1. A debug circuit, which is a circuit provided in an information processing device and performing debugging of a polling program that polls a flag of a control register used for control on a peripheral function of the information processing device, the debug circuit comprising:
an execution instruction detection circuit that detects an execution instruction of the peripheral function to generate a detection signal;
an expected value comparison circuit that compares a flag value of a flag read from the control register against an expected value of the flag; and
a polling time measurement circuit that measures a polling value related to polling of the flag of the control register based on the detection signal and a comparison result obtained by the expected value comparison circuit.

2. The debug circuit according to claim 1, wherein, after detection of the execution instruction by the execution instruction detection circuit, the polling time measurement circuit measures, as the polling value, a time until the flag value of the flag read from the control register and the expected value of the flag change from a mismatch state to a match state.

3. The debug circuit according to claim 1, wherein, after the flag value of the flag read from the control register and the expected value of the flag change from a mismatch state to a match state, the polling time measurement circuit measures, as the polling value, a time until polling of the flag of the control register starts.

4. The debug circuit according to claim 1, wherein, after polling of the flag of the control register starts, the execution instruction detection circuit counts a count of pollings executed until the flag value of the flag read from the control register and the expected value of the flag change from a mismatch state to a match state.

5. The debug circuit according to claim 1, wherein, after detection of the execution instruction by the execution instruction detection circuit, the polling time measurement circuit measures, as the polling value, a time until the flag value of the flag read from the control register and the expected value of the flag change from a match state to a mismatch state.

6. The debug circuit according to claim 1, wherein the polling time measurement circuit comprises a register readable from outside, and stores the polling value to the register.

7. The debug circuit according to claim 4, wherein the execution instruction detection circuit comprises a register readable from outside, and stores a count result of the count of the pollings to the register.

8. An information processing system composed of an information processing device and an external device connected to the information processing device via a bus line, wherein
the information processing device comprises a debug circuit performing debugging of a polling program that polls a flag of a control register used for control on a peripheral function of the information processing device,
the debug circuit comprises:
an execution instruction detection circuit that detects an execution instruction of the peripheral function to generate a detection signal;
an expected value comparison circuit that compares a flag value of a flag read from the control register against an expected value of the flag; and
a polling time measurement circuit that measures a polling value related to polling of the flag of the control register based on the detection signal and a comparison result obtained by the expected value comparison circuit, and
the external device acquires a measurement result of the polling time measurement circuit via the bus line and displays the measurement result in a visually confirmable manner.

9. The information processing system according to claim 8, wherein, after detection of the execution instruction by the execution instruction detection circuit, the polling time measurement circuit measures, as the polling value, a time until the flag value of the flag read from the control register and the expected value of the flag change from a mismatch state to a match state.

10. The information processing system according to claim 8, wherein, after the flag value of the flag read from the control register and the expected value of the flag change from a mismatch state to a match state, the polling time measurement circuit measures, as the polling value, a time until polling of the flag of the control register starts.

11. The information processing system according to claim 8, wherein, after polling of the flag of the control register starts, the execution instruction detection circuit counts a count of pollings executed until the flag value of the flag read from the control register and the expected value of the flag change from a mismatch state to a match state.

12. The information processing system according to claim 8, wherein, after detection of the execution instruction by the execution instruction detection circuit, the polling time measurement circuit measures, as the polling value, a time until the flag value of the flag read from the control register and the expected value of the flag change from a match state to a mismatch state.

13. The information processing system according to claim 8, wherein the polling time measurement circuit comprises a register readable from outside, and stores the polling value to the register.

14. The information processing system according to claim 11, wherein the execution instruction detection circuit comprises a register readable from outside, and stores a count result of the count of the pollings to the register.
